(19) United States
(12) Patent Application Publication
(10) Pub. No.: US 2026/0005273 A1
(43) Pub. Date: Jan. 1, 2026

(54) SYSTEM AND METHOD FOR THERMALLY REGULATING A SOLID OR POLYMER ELECTROLYTE IN AN ELECTROCHEMICAL DEVICE

(71) Applicant: ELLONA, Toulouse (FR)

(72) Inventor: Ivan ROMANYTSIA, Toulouse (FR)

(21) Appl. No.: 18/868,149

(22) PCT Filed: May 22, 2023
(86) PCT No.: PCT/EP2023/063560

§ 371 Date: Sep. 19, 2025

(30) Foreign Application Priority Data
May 25, 2022 (FR) 2205015

(51) Int. Cl. H01M 8/04701; H01M 8/04007; H01M 8/04537; H01M 8/04858; H01M 8/10; H01M 8/12

(52) U.S. Cl. CPC H01M 8/04731; H01M 8/04037; H01M 8/04544; H01M 8/04574; H01M 8/04634; H01M 8/04947; H01M 2008/1095; H01M 2008/1293

(57) ABSTRACT

The invention relates to a thermal regulation system, comprising:—an electrochemical device comprising two electrodes and a solid or polymer electrolyte,—a heating element configured to heat the electrolyte,—a control device configured to control the heating power of the heating element, and—a measurement device configured to apply, between the electrodes, a sinusoidal voltage signal having a predetermined reference frequency and to measure, in response, a sinusoidal intensity signal, the control device being configured to determine a measure of resistance of the electrolyte, and, if the measure of resistance is below a predetermined minimum threshold corresponding to a maximum acceptable temperature of the electrolyte , decrease the value of the heating power of the heating element.

### TECHNICAL FIELD

The present invention relates to the field of thermal regulation of a solid or polymer electrolyte in an electrochemical device.

In a known manner, the integration of a solid or polymer electrolyte into an electrochemical device, such as an electrochemical sensor or a fuel cell, has the advantage of making the electrochemical device more heat-resistant. Indeed, liquid or gel electrolytes have a risk of drying and chemical decomposition at high temperatures, which can lead to overheating. The use of solid electrolytes therefore reduces this risk and increases safety in use.

In practice, it is necessary to heat the electrolyte to ensure proper operation of the electrochemical device, i.e. to generate a measurement representative of a gas element for an electrochemical sensor or to produce sufficient electricity in the case of a fuel cell. The temperature to achieve sufficient electrical conductivity of the electrolyte varies depending on the electrolyte material, from 25° C. to 200° C. for a polymer and up to 900° C. for some solid electrolytes.

In a known manner, heating is traditionally carried out by a resistive circuit connected in contact with one face of the electrolyte, which ensures constant heating of the electrolyte. In practice, such heating does not keep the electrolyte at a constant temperature because the electrolyte is subject to heat losses varying as a function of the outside air temperature. Such temperature deviations have the effect of changing electrical conductivity of the electrochemical device, which can undesirably disturb measurements of an electrochemical sensor or electric power generation of a fuel cell.

To avoid this drawback, a solution taught in patent application CN113161574A would be to integrate a temperature sensor to take the outside temperature into account in determining the heating power of the resistive circuit. However, such a temperature sensor would undesirably increase the cost and complexity of the electrochemical device.

From patent application US2012/270124A1, it is known to adapt temperature of a solid electrolyte fuel cell by adapting the amount of fuel and/or oxidant gas supplied to the cell. Such a solution causes an unwanted change in yield and is not accurate.

In another field, to measure instability or clogging of a fuel cell, from patent application US2012/105075A1, it is known to apply an electric current to the cell including a sequence of sinusoidal disturbances with low frequencies.

The invention thus aims at regulating temperature of the solid or polymer electrolyte in an electrochemical device in a simple, accurate and reliable manner.

### DESCRIPTION OF THE INVENTION

The invention relates to a system for thermally regulating a solid or polymer electrolyte comprising:
at least one electrochemical device comprising at least two electrodes and at least one solid or polymer electrolyte electrically connecting the electrodes,
at least one heating element configured to heat the electrolyte, and
at least one control device configured to control heating power of the heating element,

The invention is remarkable in that:
the thermal regulation system comprises at least one measurement device configured to:
   apply, between the electrodes, one of at least one sinusoidal voltage or current signal at at least one predetermined reference frequency, and
   responsively measure, between the electrodes, the other of at least one sinusoidal current or voltage signal at said reference frequency, and
the control device being electrically connected to the measurement device, the control device being configured to:
determine at least one resistance measurement of the electrolyte at said reference frequency from the sinusoidal voltage signal and the sinusoidal current signal,
compare the resistance measurement to a predetermined minimum threshold at said reference frequency and corresponding to a maximum acceptable temperature of the electrolyte, and
if the resistance measurement is less than said minimum threshold, decrease the value of heating power of the heating element, to decrease temperature of the electrolyte.

The invention advantageously makes it possible to promote performance of a solid or polymer electrolyte electrochemical device, by keeping the temperature of the electrolyte in an optimal and constant operating range. The thermal regulation system advantageously makes it possible to accurately and reliably determine the resistance of the electrolyte, taking the thermal losses that the electrolyte undergoes into account. The temperature is advantageously controlled simply by measuring the electrical resistance, which is sensitive to small temperature variations. By virtue of the invention, the operational use of the electrochemical device remains effective despite variations in outside temperature.

According to one aspect of the invention, the control device is configured to:
compare the resistance measurement to a predetermined maximum threshold at said reference frequency and corresponding to a minimum acceptable temperature of the electrolyte, and
if the resistance measurement is greater than this maximum threshold, increase the value of heating power of the heating element, to increase temperature of the electrolyte.

The control device advantageously makes it possible to simply and conveniently keep temperature of the electrolyte in an optimal and constant operating range defined between a minimum threshold and a maximum threshold.

According to one aspect of the invention, the reference frequency is between 10 Hz and 1 MHz, preferably between 1 kHz and 1 MHz, preferably between 10 kHz and 1 MHz. Such high frequencies allow the electrical resistive behavior of the electrolyte to be measured distinctly, without including that of the electrodes.

According to a first aspect of the invention, the electrochemical device is in the form of an electrochemical sensor for at least one gas element. The invention advantageously makes it possible to improve measurement accuracy and reliability of solid or polymer electrolyte electrochemical sensors. The measurement of a gas element is thus independent of the external temperature conditions.

According to a second aspect of the invention, the electrochemical device is in the form of a fuel cell. The invention advantageously makes it possible to promote electric power generation of a fuel cell.

According to one aspect of the invention:
the measurement device is configured to:
   apply, between the electrodes, one of at least one sinusoidal voltage or current signal at a plurality of predetermined reference frequencies, and
   responsively measure, between the electrodes, the other of at least one sinusoidal current or voltage signal at each reference frequency, and
   the control device is configured to:
   determine at least one electrolyte resistance measurement for each reference frequency,
   compare each resistance measurement to a predetermined minimum threshold of the same reference frequency, and
   if at least one resistance measurement is less than the minimum threshold of the same reference frequency, decrease the value of heating power of the heating element, to decrease temperature of the electrolyte.

According to a preferred aspect of the invention, the control device is configured to:
compare each resistance measurement to a predetermined maximum threshold of the same reference frequency, and
if at least one resistance measurement is greater than the maximum threshold of the same reference frequency, increase the value of heating power of the heating element, to increase temperature of the electrolyte.

A plurality of measurement points at different reference frequencies enables more accurate and reliable temperature regulation.

The invention also relates to a method for thermally regulating a solid or polymer electrolyte by means of a thermal regulation system as previously described, said method comprising:
at least one step of applying, between the electrodes, one of a sinusoidal voltage or current signal at at least one predetermined reference frequency,
at least one step of responsively measuring, between the electrodes, the other of a sinusoidal current or voltage signal at said reference frequency,
at least one step of determining a resistance measurement of the electrolyte at said reference frequency, from the sinusoidal voltage signal and the sinusoidal current signal,
at least one step of comparing the resistance measurement to a predetermined minimum threshold at said reference frequency and corresponding to a maximum acceptable temperature of the electrolyte, and
if the resistance measurement is less than said minimum threshold, a step of decreasing the value of heating power of the heating element, to decrease temperature of the electrolyte.

Such a method is advantageously convenient and quick to implement, by simply measuring the resistive electrical behavior of the electrolyte and comparing it to a predetermined threshold. The electrolyte resistance is sensitive to small temperature variations, thereby allowing accurate control without the need for an overly expensive and complex temperature sensor.

According to one aspect of the invention, the method further comprises:
at least one step of comparing the resistance measurement to a predetermined maximum threshold at said reference frequency and corresponding to a minimum acceptable temperature of the electrolyte,
if the resistance measurement is greater than said maximum threshold, a step of increasing the value of heating power of the heating element, to increase temperature of the electrolyte.

According to one aspect of the invention, the method is repeated until the resistance measurement is between the minimum threshold and the maximum threshold. The minimum threshold and maximum threshold allow the electrolyte to be kept within an optimal operating range for the operational use of the electrochemical device.

According to a preferred aspect, the method comprises:
at least one step of applying, between the electrodes, one of a sinusoidal voltage or current signal at a plurality of predetermined reference frequencies,
at least one step of responsively measuring, between the electrodes, the other of a sinusoidal current or voltage signal at each reference frequency,
at least one step of determining a resistance measurement of the electrolyte at each reference frequency, from the sinusoidal voltage signal and the sinusoidal current signal,
at least one step of comparing each resistance measurement to a predetermined minimum threshold of the same reference frequency and corresponding to a maximum acceptable temperature of the electrolyte, and
if at least one resistance measurement is less than said minimum threshold of the same reference frequency, a step of decreasing the value of heating power of the heating element, to decrease temperature of the electrolyte.

According to a preferred aspect, the method further comprises:
at least one step of comparing each resistance measurement to a predetermined maximum threshold of the same reference frequency and corresponding to a minimum acceptable temperature of the electrolyte,
if at least one resistance measurement is greater than said maximum threshold of the same reference frequency, a step of increasing the value of heating power of the heating element, to increase temperature of the electrolyte.

According to one aspect of the invention, the method comprises at least one standby phase between two operational use phases of the electrochemical device, said method being implemented during a standby phase. The thermal regulation method is advantageously implemented when the electrochemical device is in the standby phase to avoid any interference that could distort the resistance measurement or impact the operational use of the electrochemical device.

According to a preferred aspect, the method further comprises, initially during a calibration phase:
at an optimal temperature of the electrolyte, at least one step of applying, between the electrodes, one of a calibration sinusoidal voltage or current signal at a plurality of calibration frequencies,
at the optimum temperature of the electrolyte, at least one step of responsively measuring, between the electrodes, the other of a calibration sinusoidal current or voltage signal at each calibration frequency,
at least one step of selecting at least one reference frequency from the calibration frequencies,
at least one step of determining, from the sinusoidal voltage signal and the sinusoidal current signal at the reference frequency selected and at the optimal temperature, a resistance measurement defining a minimum threshold.

According to a preferred aspect, the determination step also includes, from the sinusoidal voltage signal and the sinusoidal current signal at the reference frequency selected and at the optimal temperature, determining a resistance measurement defining a maximum threshold.

According to a preferred aspect, the selection step is implemented by:
determining, at the optimal temperature, an impedance measurement for each calibration frequency from the pair of voltage and current signals of the same calibration frequency,
determining the Nyquist diagram of the impedance measurement,
selecting a reference frequency greater than or equal to a characteristic frequency defined as the minimum frequency for which the Nyquist diagram has a local minimum.

Such a selection makes it possible to determine a reference frequency for measuring distinctly electrical behavior of the electrolyte, without including that of the electrodes.

DESCRIPTION OF THE FIGURES

The invention will be better understood upon reading the following description, given as an example, and referring to the following figures, given as non-limiting examples, wherein identical references are given to similar objects.

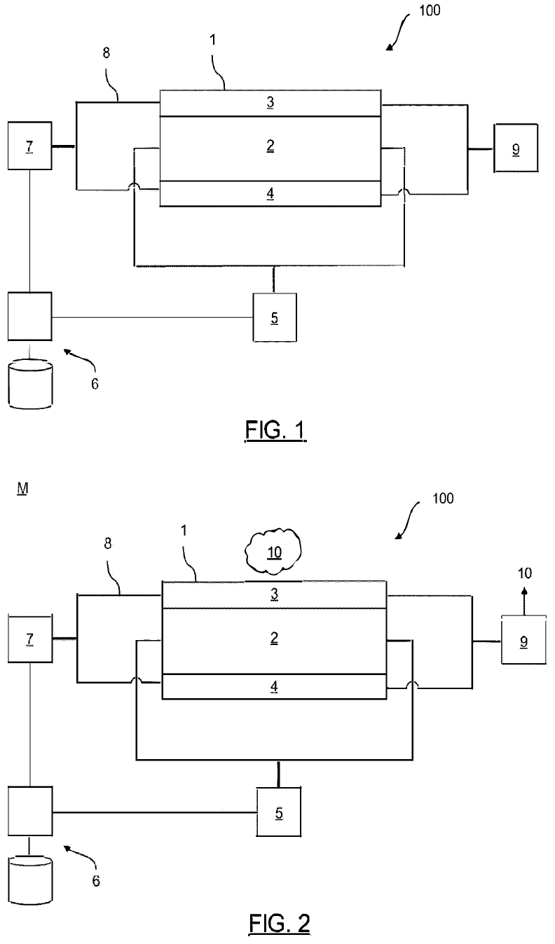

FIG. 1 is a schematic representation of a system for thermally regulating the solid or polymer electrolyte of an electrochemical sensor according to a first embodiment of the invention.

FIG. 2 is a schematic representation of the thermal regulation system of [FIG. 1] during an operational use phase of the electrochemical sensor.

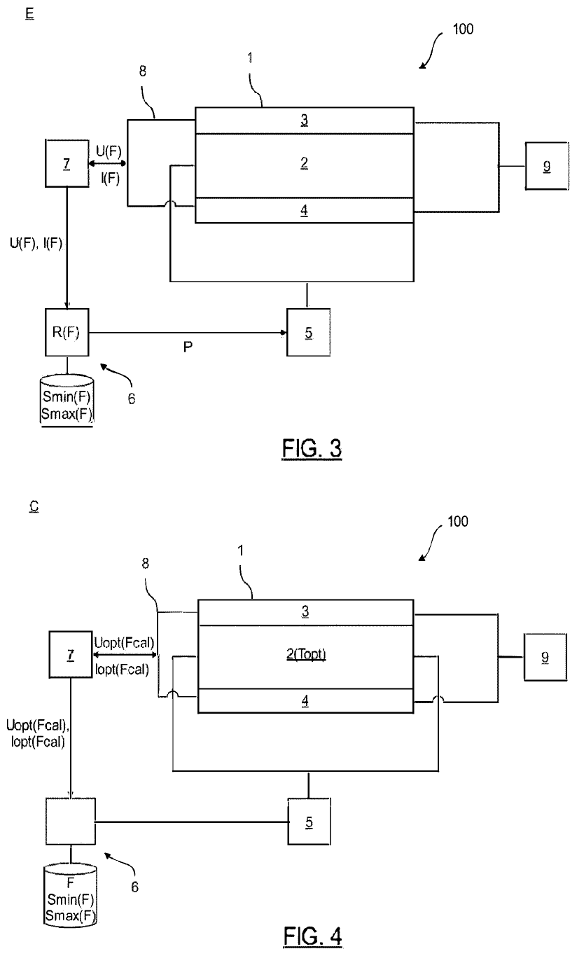

FIG. 3 is a schematic representation of the thermal regulation system of [FIG. 1] upon implementing the thermal regulation method during a standby phase of the electrochemical sensor.

FIG. 4 is a schematic representation of the thermal regulation system of [FIG. 1] during an initial calibration phase of the thermal regulation method.

FIG. 5 is a schematic representation of an electrochemical system with integrated thermal regulation according to a second embodiment of the invention with a fuel cell.

FIG. 6 is a schematic representation of the initial calibration, functional use and standby phases of the electrochemical sensor of the electrochemical system of [FIG. 1].

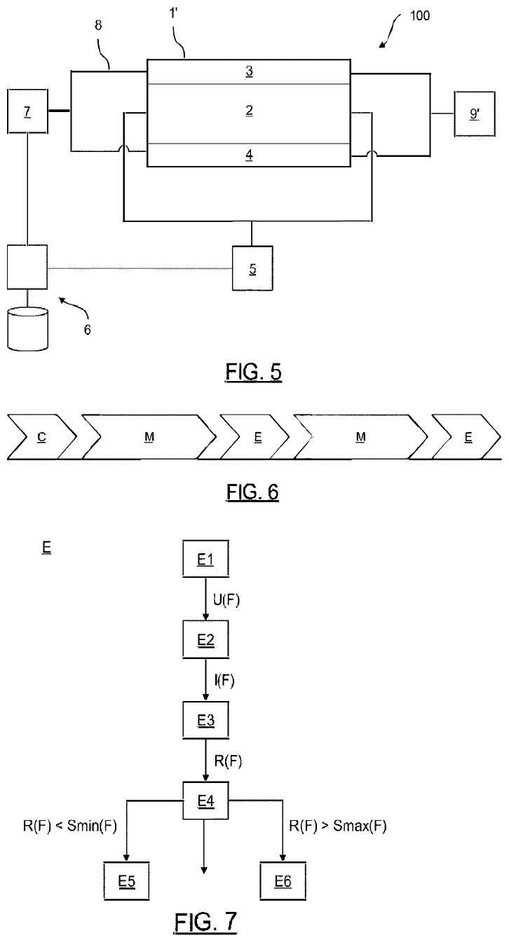

FIG. 7 is a schematic representation of the method for thermally regulating the solid or polymer electrolyte of an electrochemical system according to one embodiment of the invention.

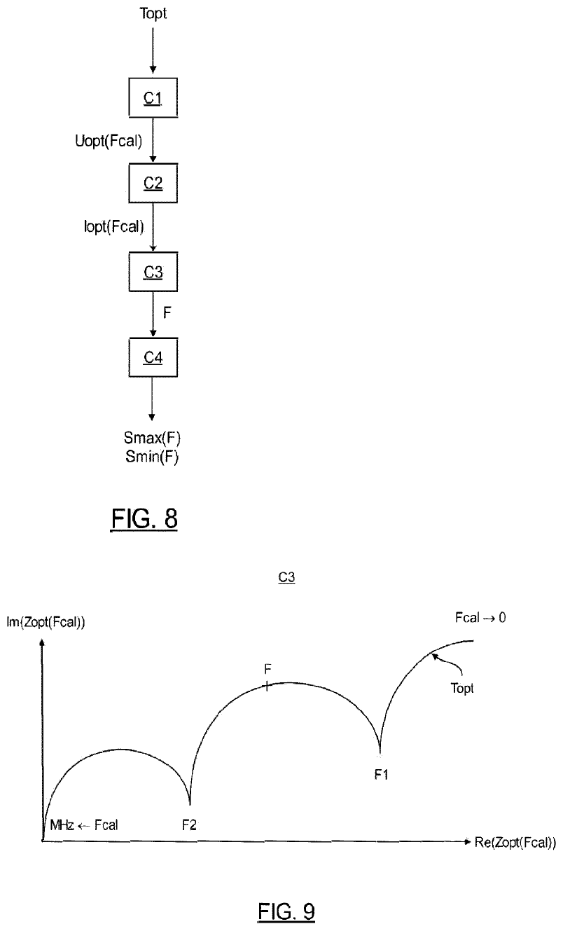

FIG. 8 is a schematic representation of the initial calibration phase of the thermal regulation method of [FIG. 7] according to one embodiment of the invention.

FIG. 9 is a schematic representation of the step of selecting a reference frequency during the initial calibration phase of [FIG. 8].

It should be noted that the figures set out the invention in detail in order to implement the invention, said figures may of course be used to better define the invention where applicable.

### DETAILED DESCRIPTION OF THE INVENTION

With reference to FIGS. 1 and 3, the invention relates to a system 100 for thermally regulating a solid or polymer type electrolyte 2 in an electrochemical device 1. The thermal regulation system 100 according to the invention comprises:
an electrochemical device 1 comprising two electrodes 3, 4 and a solid or polymer electrolyte 2 electrically connecting the electrodes 3, 4,
a heating element 5 configured to heat the electrolyte 2,
a control device 6 configured to control heating power P of the heating element 5, and
a measurement device 7 electrically connected to the control device 6.

According to the invention and as illustrated in [FIG. 3], the measurement device 7 is configured to apply, between the electrodes 3, 4, a sinusoidal voltage signal U(F) at a predetermined reference frequency F, and responsively measure a sinusoidal current signal I(F) at said reference frequency F, or reversely.

Still according to the invention and as illustrated in [FIG. 3], the control device 6 is configured to:
determine a resistance measurement R(F) of the electrolyte 2 at said reference frequency F from the sinusoidal voltage and current signals U(F), I(F),
compare the resistance measurement R(F) to:
   a predetermined minimum threshold Smin(F) at said reference frequency F and corresponding to a maximum acceptable temperature of the electrolyte 2, and
   preferably, a predetermined maximum threshold Smax(F) at said reference frequency F and corresponding to a minimum acceptable temperature of the electrolyte 2, and
if the resistance measurement R(F) is less than the minimum threshold Smin(F), decrease the value of heating power P of the heating element 5, to decrease temperature of the electrolyte 2.
preferably, if the resistance measurement R(F) is greater than the maximum threshold Smax(F), increase the value of heating power P of the heating element 5, to increase temperature of the electrolyte 2.

In the example illustrated in FIGS. 1 to 3, the electrochemical device 1 is in the form of an electrochemical sensor for one or more gas elements 10, such as an amperometric sensor or a potentiometric sensor. The electrodes 3, 4 of the electrochemical sensor 1 are usually referred to as “working electrode 3” and “counter electrode 4”. The electrochemical sensor 1 also conventionally comprises a reference electrode (not represented). The working electrode 3, the counter electrode 4 and the reference electrode are conventionally soaked in the electrolyte 2 which ensures ion conductivity. With reference to [FIG. 2], the working electrode 3 is configured to chemically react with one or more gas elements 10, causing a change in potential or intensity that is measured by a calculation member 9 and makes it possible to provide a concentration measurement of the gas element 10. The operation of an electrochemical sensor 1 is known per se to those skilled in the art and is therefore not further described.

In the example illustrated in [FIG. 5], the electrochemical device 1′ is in the form of a fuel cell. The fuel cell 1′ usually comprises several electrochemical cells (only one is represented in [FIG. 5]). Each electrochemical cell comprises electrodes 3, 4 usually referred to as “anode 3” and “cathode 4” separated by an electrolyte 2 usually referred to as “ion exchange membrane”. The anode 3 and the cathode 4 are configured to be supplied with reagents so as to generate an oxidation-reduction reaction, so as to generate electric power that drives a motor 9′. The operation of a fuel cell 1′ is known per se to those skilled in the art and is therefore not further described.

The term “electrochemical device 1, 1′” is used interchangeably hereinafter to refer to an electrochemical sensor 1 or a fuel cell 1′.

With reference to [FIG. 1], the invention is limited to solid-type or polymer-type electrolytes 2. An electrolyte 2 is said to be a solid electrolyte if it has a solid physical state. A solid electrolyte 2 includes for example a ceramic material, such as yttrium oxide stabilized zirconium (known as the acronym “YSZ”), gadolinium-doped cerium oxide (known as the acronym “GDC”), lanthanum strontium cobalt ferrite (known as the acronym “LSCF”) and/or lanthanum strontium-doped manganite (known as the acronym “LSM” or “LSMO”).

An electrolyte 2 is said to be a polymer electrolyte if it comprises at least one polymer material. A polymer electrolyte 2 is for example in the form of a gel. A polymer electrolyte 2 includes for example polyethylene glycol, polyvinyl alcohol, polymethyl methacrylate, polycaprolactone, chitosan, polyvinylpyrrolidone, polyvinyl chloride, polyvinylidene fluoride, and/or polyimide.

Such solid or polymer electrolytes 2, as opposed to liquid or gel electrolytes, are more heat-resistant and thus reduce the risk of overheating when used. This eliminates the drawback of risk of drying or chemical decomposition of liquid or gelled electrolytes. The integration of solid or polymer type electrolytes 2 in an electrochemical device 1, 1′ makes it possible in particular to increase safety when used. In order to ensure satisfactory ion conductivity, such electrolytes 2 require to be heated to a temperature usually between 25° C. to 200° C. for polymers and up to 900° C. for some solid electrolytes.

With reference to [FIG. 1], the heating element 5 is for example in the form of a resistive circuit connected in contact with one face of the electrolyte 2. This ensures predominantly conductive heating. The resistive circuit comprises for example one or more successive U-shaped resistive wires. The resistive circuit comprises a conductive material, such as platinum, iron, copper, nickel, chromium, and/or palladium, in pure or alloy form.

With reference to [FIG. 1], the measurement device 7 is connected so as to define an electrical loop 8 with the electrodes 3, 4 and the electrolyte 2. The measurement device 7 is, for example, in the form of an RLC meter. According to a first aspect of the invention, the measurement device 7 is configured to emit a sinusoidal voltage signal U(F) and responsively measure a sinusoidal current signal I(F) with the same reference frequency F. According to a second aspect of the invention, the measurement device 7 is configured to emit a sinusoidal current signal I(F) and responsively measure a sinusoidal voltage signal U(F) with the same reference frequency F. The measurement device is preferably a high frequency voltage generator whose reference frequency F is between 10 Hz and 1 MHz, preferably between 1 kHz and 1 MHz, preferably between 10 kHz and 1 MHz.

Still with reference to [FIG. 1], the control device 6 is by way of example in the form of a microcontroller, associated with a database configured to store the minimum threshold Smin(F) and the maximum threshold Smax(F). The microcontroller is configured to perform calculation operations from data provided by the measurement device 7 and control operations of the heating element 5. The control device 6 may be in a unitary or modular form, integrated or not integrated into the measurement device 7. The control device 6 is in any form within the scope of the invention.

With reference to FIGS. 3 and 7, the invention also relates to a method for thermally regulating the electrolyte 2 in an electrochemical device 1. The method is implemented by means of the thermal regulation system 100 and comprises:
a step of applying E1, between the electrodes 3, 4, a sinusoidal voltage signal U(F) at a predetermined reference frequency F,
a step of measuring E2, between the electrodes 3, 4, a sinusoidal current signal I(F) at said reference frequency (F) responsively to the sinusoidal voltage signal U(F),
a step of determining E3 a resistance measurement R(F) of the electrolyte 2 at said reference frequency F, from the sinusoidal voltage signal U(F) and the sinusoidal current signal I(F),
a step of comparing E4 the resistance measurement R(F) to:
   a predetermined minimum threshold Smin(F) at said reference frequency F and corresponding to a maximum acceptable temperature of the electrolyte 2, and
   preferably, a predetermined maximum threshold Smax(F) at said reference frequency F and corresponding to a minimum acceptable temperature of the electrolyte 2, and
if the resistance measurement R is less than the minimum threshold Smin(F), a step of decreasing E5 the value of heating power P of the heating element 5, to decrease temperature of the electrolyte 2.
if the resistance measurement R is greater than the maximum threshold Smax(F), a step of increasing E6 the value of heating power P of the heating element 5, to increase temperature of the electrolyte 2.

According to an equivalent alternative of the invention, the method comprises:
a step of applying E1, between the electrodes 3, 4, a sinusoidal current signal I(F) at a predetermined reference frequency F, and
a step of measuring E2, between the electrodes 3, 4, a sinusoidal voltage signal U(F) at said reference frequency F responsively to the sinusoidal current signal I(F),
the other steps remain unchanged.

As illustrated in FIGS. 3 and 6, the thermal regulation method is preferably implemented during a standby phase E between two operational use phases M of the electrochemical device 1. As illustrated in [FIG. 2], in the case of an electrochemical sensor 1, an operational use phase M corresponds to a phase of measuring the concentration of one or more gas elements 10. In the case of a fuel cell 1′, an operational use phase M corresponds to a phase of generating electric energy. The thermal regulation method is thus implemented during a standby phase E, i.e. a phase of operational non-use of the electrochemical device 1, 1′, to avoid any interference that could hinder or even distort both temperature regulation and gas concentration measurement or electric energy generation.

As illustrated in [FIG. 6], the reference frequency F, the minimum threshold Smin(F) and the maximum threshold Smax(F) are preferably determined initially during a calibration phase C (described later). In practice, calibration phase C precedes an alternation of operational use phases M ([FIG. 2]) and standby phases E ([FIG. 3]). It should be noted that a standby phase E can be defined passively, by detecting the more or less prolonged operational non-use of the electrochemical device 1, 1′, or actively, by causing interruption of the operational use M of the electrochemical device 1, 1′.

With reference to FIGS. 3 and 7, the step of applying E1 a sinusoidal voltage signal U(F) at the reference frequency F is implemented by the measurement device 7 between the electrodes 3, 4. Similarly, the step E2 of responsively measuring a sinusoidal current signal I(F) of the same reference frequency F is implemented by the measurement device 7. According to one aspect of the invention, the application E1 and measurement E2 steps are repeated several times for several different predetermined reference frequencies F, in order to obtain several measurement points for more accurate and more reliable thermal regulation. According to one aspect of the invention, the application E1 and measurement E2 steps are repeated several times for the same reference frequency F. The redundancy of measurements also allows more reliable thermal regulation. At the end of application E1 and measurement E2 steps, the sinusoidal voltage and current signals U(F), I(F) are transmitted to the control device 6. Alternatively equivalently, steps E1 and E2 may be implemented by emitting a sinusoidal current signal I(F) and measuring a sinusoidal voltage signal U(F).

With reference to FIGS. 3 and 7, the step of determining E3 a resistance measurement R(F) is then implemented by the control device 6. From a pair of sinusoidal voltage and current signals U(F), I(F) of the same reference frequency F, the control device 6 calculates the impedance Z(F) of the electrolyte 2 at the reference frequency F as follows: Z(F)=U(F)/I(F). The control device 6 then calculates the resistance measurement R(F) of the electrolyte 2 at the reference frequency F as follows: R(F)=Re(Z(F)), where Re is the real part of the impedance Z(F).

At the end of the determination step E3, a resistance measurement R(F) is determined for each pair of sinusoidal voltage and current signals U(F), I(F) of the same reference frequency F. As will be seen later with the calibration phase C, each reference frequency F is chosen high enough to represent the electrical behavior of the electrolyte 2 considered distinctly from the electrodes 3, 4. Each resistance measurement R(F) is thus representative, at a given frequency F, of the electrical resistance of the electrolyte 2 alone.

With reference to FIGS. 3 and 7, during the comparison step E4, the control device 6 compares each resistance measurement R(F) to a minimum threshold Smin(F) and a maximum threshold Smax(F) of the same reference frequency F. Each minimum threshold Smin(F) and each maximum threshold Smax(F) is stored beforehand in the database associated with the control device 6. In practice, at a set frequency F, the temperature of the electrolyte 2 is strongly related to the electrical resistance R(F) of the electrolyte 2 and inversely proportionally varies with the electrical resistance R(F) of the electrolyte 2. Thus, for a given frequency F, a minimum threshold Smin(F) corresponds to a maximum acceptable temperature to ensure sufficient ion conductivity of the electrolyte 2. Similarly, for a given frequency F, a maximum threshold Smax(F) corresponds to a minimum acceptable temperature to ensure sufficient ion conductivity of the electrolyte 2.

With reference to FIGS. 3 and 7, for a given frequency F, the minimum threshold Smin(F) and the maximum threshold Smax(F) thus define a bounded range of electrical resistances corresponding to an acceptable operating temperature for the electrolyte 2. If the resistance measurement R(F) satisfies Smin(F)<R(F)<Smax(F), it indicates that the temperature of the electrolyte 2 allows a satisfactory operational use M of the electrochemical device 1, 1′ and the thermal regulation method is terminated. Preferably, the deviation between the minimum threshold Smin(F) and the maximum threshold Smax(F) is small to keep temperature of the electrolyte in a restricted range. A restricted range allows for higher measurement accuracy.

With reference to [FIG. 7], if the resistance measurement R(F) is less than the minimum threshold Smin(F), this indicates that the temperature of electrolyte 2 is too high. The comparison step E4 is then followed by a step E5 of decreasing heating power P of the heating element 5, in the form of a setpoint transmitted by the control device 6. With reference to [FIG. 7], if the resistance measurement R(F) is greater than the maximum threshold Smax(F), this indicates that the temperature of electrolyte 2 is too low. The comparison step E4 is then followed by a step E6 of increasing heating power P of the heating element 5, in the form of a setpoint transmitted by the control device 6.

According to a preferred aspect of the invention, the decrease step E5 and the increase step E6 are implemented respectively by removing and adding an increment set at the heating power P. The thermal regulation method is then repeated until the resistance measurement R(F) is between the minimum threshold Smin(F) and the maximum threshold Smax(F). According to another preferred aspect, the increment is variable and determined as a function of the deviation between the resistance measurement R(F) and the threshold Smin(F), Smax(F). The thermal regulation method is then preferably repeated to check that the resistance measurement R(F) is between the minimum threshold Smin(F) and the maximum threshold Smax(F).

According to a preferred aspect illustrated in FIGS. 4 and 8, each reference frequency F, each minimum threshold Smin(F) and each maximum threshold Smax(F) are determined initially during a calibration phase C. The calibration phase C precedes an operational use phase M to avoid any interference analogously to previously. The following steps are preferably implemented during calibration phase C:
at an optimal temperature Topt of the electrolyte 2, a step of applying C1, between the electrodes 3, 4, a calibration sinusoidal voltage signal Uopt(Fcal) at several calibration frequencies Fcal,
at the optimum temperature Topt of the electrolyte 2, a step C2 of measuring, between the electrodes 3, 4, a calibration sinusoidal current signal Iopt(Fcal) at each calibration frequency Fcal responsively to the calibration sinusoidal voltage signal Uopt(Fcal),
a step of selecting C3 one or more reference frequencies F from the calibration frequencies Fcal,
a step of determining C4:
   from the sinusoidal voltage signal Uopt(Fcal) and the sinusoidal current signal Iopt(Fcal) at the reference frequency F selected and at the optimum temperature Topt, a resistance measurement defining a minimum threshold Smin(F), and preferably a resistance measurement defining a maximum threshold Smax(F).

Alternatively equivalently, steps C1 and C2 may be implemented by emitting a calibration sinusoidal current signal Iopt(Fcal) and measuring a calibration sinusoidal voltage signal Uopt(Fcal).

With reference to FIGS. 4 and 8, the steps of applying C1 a voltage signal, and measuring C2 a responsive current signal differ from the steps E1, E2 of the same name previously described in that they are implemented for several calibration frequencies Fcal and at a known optimum temperature Topt of the electrolyte 2, for example measured by a temperature sensor. The optimum temperature Topt is preferably indicated by the manufacturer of the electrochemical device or determined during the calibration phase C. Preferably, steps C1, C2 are implemented over a frequency range Fcal between 10Hz and 1 MHz, preferably between 1kHz and 1 MHz, preferably between 10 kHz and 1 MHz.

According to a preferred aspect illustrated in [FIG. 9], the selection step C3 is implemented by the control device 6 by:
determining, at the optimum temperature Topt, a measurement of the impedance Zopt(Fcal) for each calibration frequency Fcal from the pair of voltage and current signals Uopt(Fcal), Iopt(Fcal) of the same calibration frequency Fcal,
determining the Nyquist diagram of the impedance Zopt(Fcal), of which the real part Rc(Zopt(Fcal)) is on the abscissa and the imaginary part Im(Zopt(Fcal)) on the ordinate,.
selecting a reference frequency F greater than or equal to a characteristic frequency F2 defined as the minimum frequency for which the Nyquist diagram has a local minimum.

Conventionally and as illustrated in [FIG. 9], the Nyquist diagram of the electrochemical device 1, 1′ has three concave portions and two frequency local minima F1, F2. The first concave portion at lower frequency Fcal (on the right in [FIG. 9]) represents the electrical behavior of the electrodes 3, 4 while the next two concave portions at higher frequency Fcal represent the electrical behavior of the electrolyte 2. The selection step C3 thus makes it possible to determine one or more reference frequencies F (only one represented by way of example in [FIG. 9]) representative of the electrical behavior of the electrolyte 2 distinctly from the electrodes 3, 4.

Following the selection step C3, the determination step C4 is preferably implemented by determining:
analogously to the determination step E3 previously described, a resistance measurement Ropt(F) of the electrolyte (2) at the optimum temperature Topt, from the sinusoidal voltage and current signals Uopt(F) and Iopt(F) at the reference frequency F and
the maximum threshold Smax(F) at the minimum acceptable temperature being defined as follows: Smax(F)=Ropt(F)+e, where e denotes a predetermined acceptable deviation, for example in the order of 1%.
the minimum threshold Smin(F) at the maximum acceptable temperature being defined as follows: Smin(F)=Ropt(F)−e.

At the end of the calibration phase C, the reference frequency F, the maximum threshold Smax(F) and the minimum threshold Smin(F) are stored in the database associated with the control device 6. The calibration phase C advantageously makes it possible to determine a reference frequency F and thresholds Smin(F), Smax(F) specific to the electrochemical device 1, 1′, for accurate and reliable thermal regulation.

1.-9. (canceled)

10. A system for thermally regulating at least one solid or polymer electrolyte comprising:
at least one electrochemical device comprising at least two electrodes and the at least one solid or polymer electrolyte electrically connecting the at least two electrodes,
at least one heating element configured to heat the at least one solid or polymer electrolyte, and
at least one control device configured to control heating power of the at least one heating element,
at least one measurement device configured to:
apply, between the at least two electrodes, one of at least one sinusoidal voltage or current signal at at least one predetermined reference frequency, the at least one predetermined reference frequency being between 10 kHz and 1 MHz, and
responsively measure, between the at least two electrodes, the other of the at least one sinusoidal current or voltage signal at said at least one predetermined reference frequency,
the at least one control device being electrically connected to the at least one measurement device, the at least one control device being configured to:
determine at least one resistance measurement of the at least one solid or polymer electrolyte at said at least one predetermined reference frequency from the at least one sinusoidal voltage signal and the at least one sinusoidal current signal,
compare the at least one resistance measurement to a predetermined minimum threshold at said at least one predetermined reference frequency and corresponding to a maximum acceptable temperature of the at least one solid or polymer electrolyte, and
if the at least one resistance measurement is less than said predetermined minimum threshold, decrease the value of heating power of the at least one heating element, to decrease temperature of the at least one solid or polymer electrolyte.

11. The thermal regulation system according to claim 10, wherein the at least one control device is configured to:
compare the at least one resistance measurement to a predetermined maximum threshold at said at least one predetermined reference frequency and corresponding to a minimum acceptable temperature of the at least one solid or polymer electrolyte, and
if the at least one resistance measurement is greater than said predetermined maximum threshold, increase the value of heating power of the at least one heating element, to increase temperature of the at least one solid or polymer electrolyte.

12. The thermal regulation system according to claim 10, wherein the at least one electrochemical device is in the form of an electrochemical sensor for at least one gas element.

13. The thermal regulation system according to claim 10, wherein the at least one electrochemical device is in the form of a fuel cell.

14. The thermal regulation system according to claim 10, wherein:
the at least one measurement device is configured to:
apply, between the at least two electrodes, one of the at least one sinusoidal voltage or current signal at a plurality of predetermined reference frequencies, and
responsively measure, between the at least two electrodes, the other of the at least one sinusoidal current or voltage signal at each of the plurality of predetermined reference frequencies,
the at least one control device being configured to:
determine the at least one resistance measurement of the at least one solid or polymer electrolyte for each of the plurality of predetermined reference frequencies,
compare each resistance measurement to the predetermined minimum threshold of the same predetermined reference frequency, and
if at least one of the resistance measurements is less than the predetermined minimum threshold of the same predetermined reference frequency, decrease the value of heating power of the at least one heating element, to decrease temperature of the at least one solid or polymer electrolyte.

15. A method for thermally regulating at least one solid or polymer electrolyte by means of a thermal regulation system according to claim 10, said method comprising:
at least one step of applying, between the at least two electrodes, one of the at least one sinusoidal voltage or current signal at the at least one predetermined reference frequency,
at least one step of responsively measuring, between the at least two electrodes, the other of the at least one sinusoidal current or voltage signal at said predetermined reference frequency,
at least one step of determining the at least one resistance measurement of the at least one solid or polymer electrolyte at said at least one predetermined reference frequency, from the at least one sinusoidal voltage signal and the at least one sinusoidal current signal,
at least one step of comparing the at least one resistance measurement to the predetermined minimum threshold at said at least one predetermined reference frequency and corresponding to the maximum acceptable temperature of the at least one solid or polymer electrolyte,
if the at least one resistance measurement is less than said predetermined minimum threshold, a step of decreasing the value of heating power of the a least one heating element, to decrease temperature of the at least one solid or polymer electrolyte.

16. The thermal regulation method according to claim 15, further comprising:
at least one step of comparing the at least one resistance measurement to the predetermined maximum threshold at said at least one predetermined reference frequency and corresponding to the minimum acceptable temperature of the at least one solid or polymer electrolyte,
if the at least one resistance measurement is greater than said predetermined maximum threshold, a step of increasing the value of heating power of the at least one heating element, to increase temperature of the at least one solid or polymer electrolyte.

17. The thermal regulation method according to claim 16, which is repeated until the at least one resistance measurement is between the predetermined minimum threshold and the predetermined maximum threshold.

18. The thermal regulation method according to claim 15, comprising at least one standby phase between two operational use phases of the at least one electrochemical device, said method being implemented during a standby phase.
